(19) United States
(12) Patent Application Publication
(10) Pub. No.: US 2018/0056556 A1
(43) Pub. Date: Mar. 1, 2018

(54) METHOD FOR PRODUCING A PLASTIC COMPONENT FOR THE INTERIOR OF A MOTOR VEHICLE, AND PLASTIC COMPONENT

(71) Applicant: Illinois Tool Works, Inc., Glenview, IL (US)

(72) Inventor: Klaus Hildebrandt, Kaiserslautern (DE)

(73) Assignee: Illinois Tool Works Inc., Glenview, IL (US)

(21) Appl. No.: 15/555,157

(22) PCT Filed: Mar. 9, 2016
(86) PCT No.: PCT/EP2016/055016

§ 371 Date: Sep. 1, 2017

(30) Foreign Application Priority Data
Mar. 11, 2015 (DE) 10 2015 103 585.5

(51) Int. Cl. B29C 45/00

(52) U.S. Cl. CPC B29C 45/0005; B29K 2077/00

(57) ABSTRACT

Method for producing a plastic component for the interior of a motor vehicle. According to said method, secondary carbon fibers are provided and those secondary carbon fibers are added to a polymer and a plastic component is formed from said polymer.

### BACKGROUND OF THE DISCLOSURE

The invention relates to a method for producing a plastic component for the interior of a motor vehicle. The invention further relates to such a plastic component.

Many components within the interior of a motor vehicle, such as air dischargers, by means of which air is fed into the vehicle interior for air conditioning, covers, for instance center arm resting consoles or glove compartments, light shades, switches, etc. are made of plastic. In many cases polyamide is used therefor. For components with enhanced mechanical stability often plastics are utilized which are reinforced by fiber glass additions.

Such fiber glass reinforced plastic materials suffer from the drawback that they have a comparatively high weight. In addition the chemical resistance is not optimal. Still further these materials should be improved with respect with to environmental considerations.

### BRIEF DESCRIPTION OF THE DISCLOSURE

In an embodiment, a method for producing a plastic component for the interior of a motor vehicle is described, wherein secondary carbon fibers are provided, the secondary carbon fibers are added to a polymer, and a plastic component is shaped from the polymer.

### DETAILED DESCRIPTION OF THE DISCLOSURE

It is the object of the invention to provide plastic components that fulfill demanding environmental criteria that have a low weight and increased chemical resistance.

This object according to the invention is solved by a method for producing a plastic component for the interior of a motor vehicle, wherein secondary carbon fibers are provided, the secondary carbon fibers are added to a polymer, and from the polymer a plastic component is formed. For solving this object according to the invention there is also provided a plastic component that is produced using such a method.

The invention rests on the basic concept that instead of the glass fibers used in the prior art that are used for reinforcing the components, secondary carbon fibers are used. Secondary carbon fibers are carbon fibers which were not produced originally for the object to reinforce the plastic component, but were produced for a different object, e.g. to be a part of a carbon fiber mat, and then they are forwarded to a secondary use. They may also be regarded as recycled plastic fibers, since they were extracted from a different product (for instance a carbon fiber mat).

The use of secondary carbon fibers leads to a variety of advantages. On the one hand glass fibers need not be provided separately, but carbon fibers can be utilized that virtually are at hand as “waste”, in particular from offcuts from carbon fiber mats (“preforms”). Thereby the consumption of resources is lowered in total so that these components are more advantageous under environmental aspects than the components known in the prior art. A further advantage rests in the fact that the component weight can be reduced by about 25% when compared to components made of glass fiber reinforced plastics while having the same mechanical characteristics. This leads to a lower CO₂ emission of the motor vehicle, wherein the components are utilized. A further advantage rests in the fact that plastic materials that are reinforced with carbon fibers have a high chemical resistance. In addition there is an excellent dimensional stability.

In particular PA6.6 or PA6.6+PA6I/6T can be utilized as a polyamide. These materials are proved and tested materials that fulfill the demands of a motor vehicle.

Preferably it is provided that the carbon fibers are made by shredding offcuts from carbon fiber mats. This makes possible to provide the desired carbon fibers in the desired fiber length with low expenditure.

The plastic components may be configured as an interior functional component, in particular an air discharger fin, a slider knob, a rotary knob, or a push button. The plastic component may also be configured as an interior cover component, in particular a center arm resting console, a cup holder, or an instrument panel cover. It is also conceivable that the plastic component is a mechanical component, in particular a connector rod for the fins of an air discharger, a connector fork, a lever or a gearwheel.

All these components benefit in a particular way from the high mechanical stability of carbon fiber reinforced plastic materials.

1. Method for producing a plastic component for an interior of a motor vehicle, wherein the method comprises:
providing secondary carbon fibers;
adding the secondary carbon fibers to a polymer;
shaping a plastic component from the polymer.

2. Method of claim 1, wherein the polymer includes a polyamide.

3. Method of claim 2, wherein the polyamide is PA6.6 or PA6.6+PA6I/6T.

4. Method of claim 1, wherein the plastic component is injection molded.

5. Method of claim 1, wherein the secondary carbon fibers are obtained from secondary carbon fiber mats, from offcuts of carbon fiber mats, from carbon fiber knitted fabrics, or from carbon fiber fabrics.

6. Method of claim 5, wherein the offcuts are shredded.

7. Plastic component produced according to the method of claim 1.

8. Plastic component of claim 7, wherein the plastic component is an interior functional component.

9. Plastic component of claim 7, wherein the plastic component is an interior cover panel part.

10. Plastic component of claim 7, wherein the plastic component is a mechanical component.

11. Plastic component of claim 8, wherein the interior functional component is one of an air dispenser fin, a slider knob, a rotary knob, or a push button.

12. Plastic component of claim 9, wherein the interior cover panel is one of an air dispenser baffle, a center resting arm console, a cup holder, or a dashboard lining.

13. Plastic component of claim 10, wherein the mechanical component is one of a connection rod for fins of an air dispenser, a connection rod, a lever, or a gear wheel.
